(19) United States
(12) Patent Application Publication
(10) Pub. No.: US 2026/0181331 A1
(43) Pub. Date: Jun. 25, 2026

(54) Speaker

(71) Applicant: AAC Microtech (Changzhou) Co., Ltd., Changzhou City, Jiangsu (CN)

(72) Inventors: Huhu Yang, Changzhou (CN); Zhaoyu Yin, Changzhou (CN); Wei Wei, Changzhou (CN); Zhizhu Chen, Changzhou (CN)

(21) Appl. No.: 19/287,838

(22) Filed: Aug. 1, 2025

Related U.S. Application Data
(63) Continuation of application No. PCT/CN2024/141859, filed on Dec. 24, 2024.

(51) Int. Cl. H04R 9/02; H04R 7/04; H04R 7/18; H04R 9/06

(52) U.S. Cl. CPC H04R 9/025; H04R 7/04; H04R 7/18; H04R 9/06; H04R 2400/11

(57) ABSTRACT

The present application provides a speaker including a frame having an accommodation space, a vibration system, and a magnetic circuit system. The magnetic circuit system includes a yoke, a main magnet, and an auxiliary magnet spaced apart from the main magnet. The vibration system includes a diaphragm and a voice coil. The diaphragm includes a dome and a suspension spaced and surrounding the dome. The auxiliary magnet includes a first auxiliary magnet and a second auxiliary magnet. The speaker of the present application has one FPC board disposed between the frame and the first auxiliary magnet, and a width of the second auxiliary magnet is greater than a width of the first auxiliary magnet, which effectively improves the acoustic performance of the speaker.

### TECHNICAL FIELD

The present application relates to the field of electroacoustic transduction, particularly to a speaker.

### BACKGROUND

A speaker typically includes a frame having an accommodation space, a vibration system accommodated in the frame, and a magnetic circuit system driving the vibration system to vibrate. The speaker mainly connects to external circuits and the voice coil through FPC boards, and then the vibration of the voice coil in the magnetic field drives the diaphragm to vibrate and produce sound.

However, in the prior art, due to two symmetrically disposed FPC boards between the magnet unit and the frame of the speaker, the volume of the magnetic circuit system is significantly limited under a fixed overall speaker volume, thereby limiting the acoustic performance of the speaker in the prior art.

Therefore, it is necessary to provide a new speaker to solve the above technical problems.

### SUMMARY

The object of the present application is to provide a speaker with an enlarged magnetic circuit volume for achieving a better acoustic performance.

To achieve the above purposes, the present invention provides a speaker, comprising a frame having an accommodation space, a vibration system accommodated in the frame, and a magnetic circuit system driving the vibration system to vibrate. The magnetic circuit system comprises a yoke spaced apart from the frame, a main magnet fixed on the yoke, and an auxiliary magnet spaced apart from the main magnet. The vibration system comprises a diaphragm fixed to the frame and a voice coil driving the diaphragm to vibrate and produce sound; the diaphragm comprises a dome positioned in the middle and a suspension spaced and surrounding the dome; the auxiliary magnet comprises a first auxiliary magnet and a second auxiliary magnet respectively disposed on both sides of the main magnet along a first direction perpendicular to a vibration direction. The first auxiliary magnet and the frame are spaced apart along the first direction, a width of the second auxiliary magnet along the first direction is greater than a width of the first auxiliary magnet along the first direction. The speaker further comprises a flexible printed circuit (FPC) board electrically connected to the voice coil, a number of the FPC board is one and the FPC board is disposed between the frame and the first auxiliary magnet.

In addition, along the first direction, a geometric center of the voice coil is located on a side of a geometric center of the diaphragm away from the FPC board.

In addition, the diaphragm is rectangular, the suspension comprises a first suspension and a second suspension symmetrically disposed along a center line parallel to a short axis direction, and the first suspension and the first auxiliary magnet are relatively spaced apart along the vibration direction.

In addition, the second suspension comprises a thickened portion, and a thickness of the thickened portion is greater than a thickness of the first suspension.

In addition, a thickness of the second suspension is greater than a thickness of the first suspension.

In addition, the second auxiliary magnet and the frame are relatively disposed along the vibration direction.

In addition, the frame is rectangular, and the first direction is parallel to a long axis direction of the frame.

In addition, the magnetic circuit system further comprises a main pole piece located above the main magnet and an auxiliary pole piece located above the auxiliary magnet, the auxiliary pole piece comprises a first auxiliary pole piece and a second auxiliary pole piece respectively disposed on both sides of the main pole piece along the first direction, and a width of the second auxiliary pole piece in the first direction is greater than a width of the first auxiliary pole piece in the first direction.

In addition, the dome comprises a planar portion perpendicular to the vibration direction and a side surface portion extending from a short axis edge of the planar portion toward the magnetic circuit system; the FPC board comprises a bending portion close to the voice coil and adhered to the planar portion, a first fixing portion fixed to the frame, a second fixing portion fixed to the side surface portion, a perpendicular portion connecting the bending portion and the second fixing portion, and a resilient arm connecting the first fixing portion and the second fixing portion.

Compared with the prior art, in the speaker provided by the present application, the auxiliary magnet includes a first auxiliary magnet and a second auxiliary magnet respectively disposed on both sides of the main magnet along a first direction perpendicular to the vibration direction. The speaker further includes a main pole piece and an auxiliary pole piece respectively stacked on the main magnet and the auxiliary magnet. The auxiliary pole piece includes a first auxiliary pole piece and a second auxiliary pole piece respectively disposed on both sides of the main pole piece along the first direction perpendicular to the vibration direction. One FPC board is disposed between the first auxiliary magnet and the frame in a direction perpendicular to the vibration direction, therefore the second auxiliary magnet and the second auxiliary pole piece can extend and be fixed to the frame along the first direction perpendicular to the vibration direction. The width of the second auxiliary magnet and the second auxiliary pole piece along the first direction is respectively greater than the width of the first auxiliary magnet and the second auxiliary pole piece along the first direction, which effectively increases the volume of the magnetic circuit system, thereby improving the acoustic performance of the speaker.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of a speaker according to an embodiment of the present application;

FIG. 2 is an exploded view of the speaker shown in FIG. 1;

FIG. 3 is a cross-sectional view taken along line A-A in FIG. 1;

FIG. 4 is a top view of a combined structure of an FPC board, a main magnet, and an auxiliary magnet of the speaker shown in FIG. 1;

FIG. 5 illustrates a combined structure of the FPC board, a voice coil, a frame, and a diaphragm of the speaker shown in FIG. 1;

FIG. 6 is a partial exploded view of the speaker shown in FIG. 1;

FIG. 7 is a top view of a combined structure of the FPC board and the diaphragm of the speaker shown in FIG. 1;

FIG. 8 is an isometric view of a speaker according to another embodiment of the present application;

FIG. 9 is a cross-sectional view of the speaker taken along line B-B in FIG. 8.

### DETAILED DESCRIPTION OF THE EMBODIMENTS

To further explain the embodiments, the present application provides drawings. These drawings form part of the disclosure of the present application and are mainly used to explain the embodiments and can be used to explain the operating principles of the embodiments in conjunction with the related descriptions in the specification. With reference to these contents, those skilled in the art should be able to understand other possible implementations and advantages of the present application. The components in the drawings are not drawn to scale, and similar component symbols are generally used to indicate similar components.

The present application will be further described below in conjunction with the drawings and embodiments.

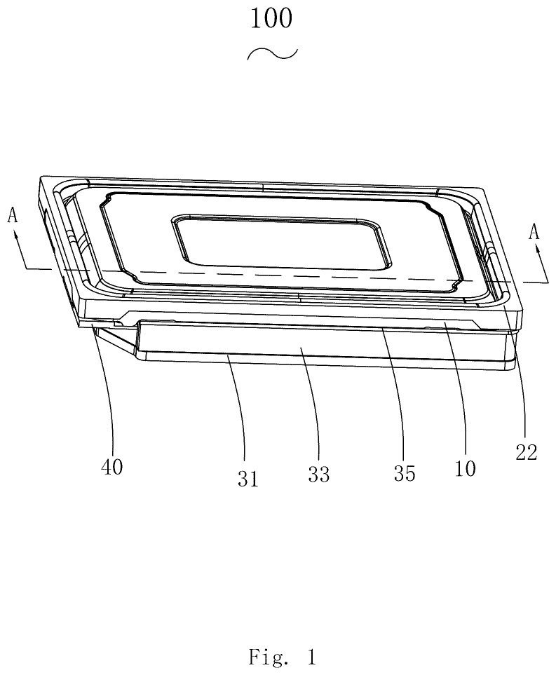

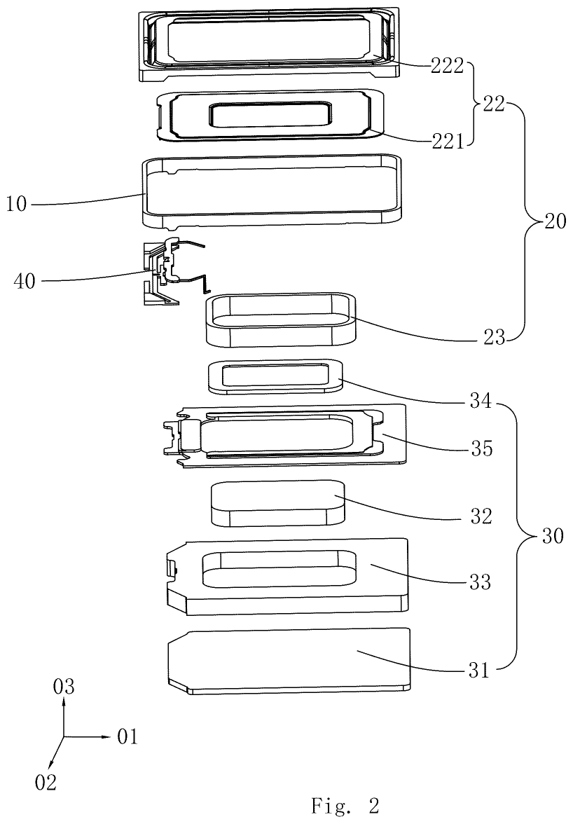

Referring to FIGS. 1 and 2, an embodiment of the present application provides a speaker 100, which includes a frame 10 having an accommodation space, a vibration system 20 accommodated in the frame 10, a magnetic circuit system 30 driving the vibration system 20 to vibrate, and a FPC board 40 for electrically connecting the speaker 100 and external circuits. The magnetic circuit system 30 and the vibration system 20 are fixed to the frame 10, the frame 10 can support the magnetic circuit system 30 and the vibration system 20, and the frame 10 is rectangular.

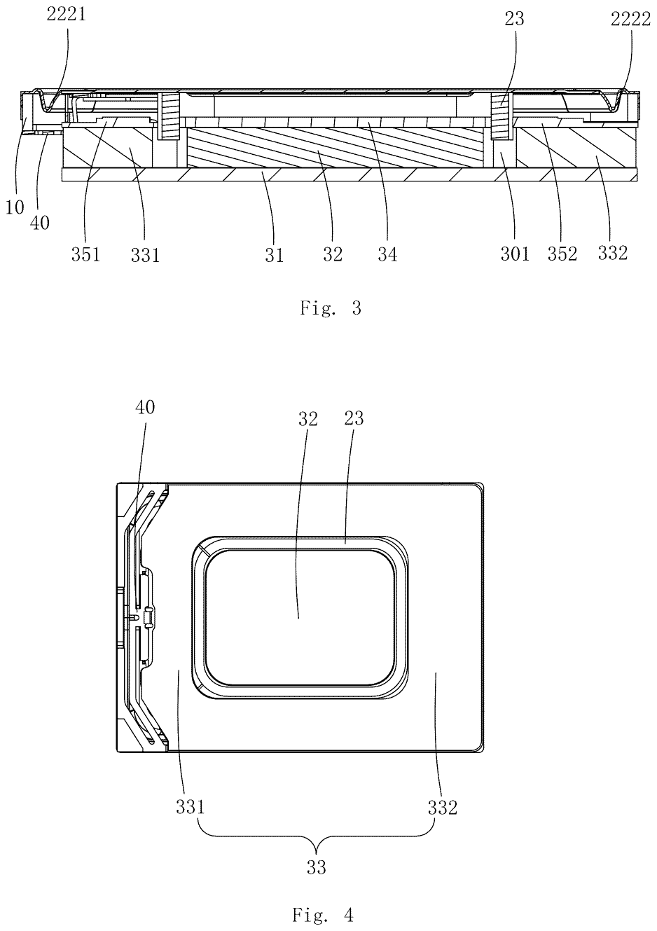

Referring to FIGS. 1, 2, and 3, the vibration system 20 includes a diaphragm 22 fixed to the frame 10 and a voice coil 23 driving the diaphragm 22 to vibrate and produce sound. The FPC board 40 introduces electrical signals to the voice coil 23. When the speaker 100 is connected to power, the voice coil 23 vibrates under the action of the magnetic circuit system 30, thereby driving the diaphragm 22 to vibrate and produce sound.

Referring to FIGS. 2, 3, and 4, the magnetic circuit system 30 includes a yoke 31 spaced apart from the frame 10, and a main magnet 32 and an auxiliary magnet 33 fixed on the yoke 31 and close to the vibration system 20, the auxiliary magnet 33 is spaced and surrounds the main magnet 32. The auxiliary magnet 33 and the main magnet 32 jointly form a magnetic gap 301, and the voice coil 23 is suspended in the magnetic gap 301. The auxiliary magnet 33 includes a first auxiliary magnet 321 and a second auxiliary magnet 322 respectively disposed on both sides of the main magnet 32 along a first direction 01 perpendicular to a vibration direction 03.

Referring to FIGS. 2 and 5, the dome 221 includes a planar portion 2211 perpendicular to the vibration direction 03 and a side surface portion 2212 extending from the edge of the planar portion 2211 toward the magnetic circuit system 30. The FPC board 40 includes a bending portion 401 close to the voice coil 23 and adhered to the planar portion 2211, a first fixing portion 402 fixed to the frame 10, a second fixing portion 403 fixed to the side surface portion 2212, a perpendicular portion 404 connecting the bending portion 401 and the second fixing portion 403, and a resilient arm 405 connecting the first fixing portion 402 and the second fixing portion 403.

In the prior art, conventional speakers have two symmetrically disposed FPC boards, which significantly limits the volume of the magnetic circuit system under a fixed overall speaker volume, thereby limiting the speaker's acoustic performance. Referring to FIGS. 2, 3, and 4, however, in the present application, only one FPC board 40 is disposed between the first auxiliary magnet 331 and the frame 10 perpendicular to the vibration direction 03. The width of the second auxiliary magnet 332 along the first direction 01 perpendicular to the vibration direction 03 is greater than the width of the first auxiliary magnet 331 along the first direction 01 perpendicular to the vibration direction 03. The optimal arrangement for the second auxiliary magnet 332 is to be relatively disposed with the frame 10 along the vibration direction 03. The magnetic circuit system 30 further includes a main pole piece 34 located above the main magnet 32 and an auxiliary pole piece 35 located above the auxiliary magnet 33. The auxiliary pole piece 35 includes a first auxiliary pole piece 351 and a second auxiliary pole piece 352 respectively disposed on both sides of the main pole piece 34 along the first direction 01 perpendicular to the vibration direction 03. Since the speaker 100 of the present application only has one FPC board 40 disposed between the magnetic circuit system 30 side with the first auxiliary magnet 331 and first auxiliary pole piece 351 and the frame 10, the width of the second auxiliary pole piece 352 and the second auxiliary magnet 332 along the first direction 01 perpendicular to the vibration direction 03 is the same. Therefore, the width of the second auxiliary pole piece 352 along the first direction 01 perpendicular to the vibration direction 03 is also greater than the width of the first auxiliary pole piece 351 along the first direction 01 perpendicular to the vibration direction 03. The optimal arrangement for the second auxiliary pole piece 352 is to be fixed to the frame 10. Compared with the prior art, the speaker 100 of the present application effectively increases the volume of the magnetic circuit system 30, thereby improving the acoustic performance of the speaker 100.

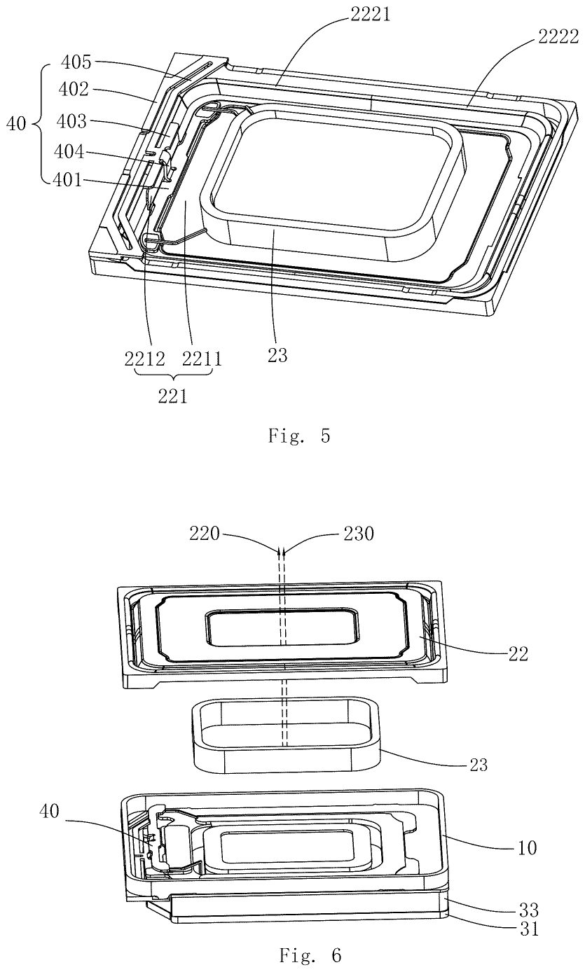

Referring to FIG. 6, along the first direction 01, the geometric center 230 of the voice coil 23 is moved to a side of the geometric center 220 of the diaphragm 22 away from the FPC board 40, which further improves the vibration balance of the vibration system 20 along the first direction 01, thereby improving the acoustic performance of the speaker 100.

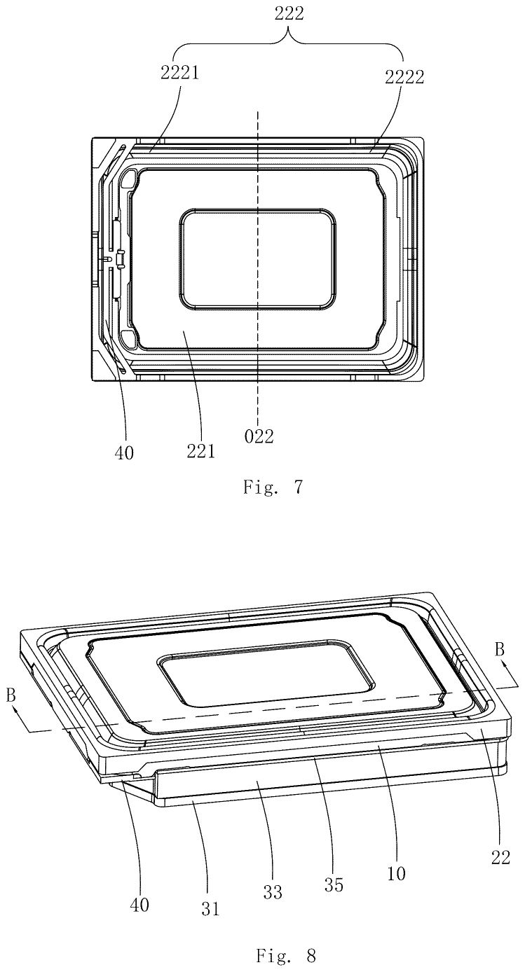

Referring to FIGS. 2 and 7, the diaphragm 22 includes a dome 221 positioned in the middle and a suspension 222 spaced and surrounding the dome 221. The diaphragm 22 is rectangular, and the suspension 222 includes a first suspension 2221 and a second suspension 2222 symmetrically disposed along a center line 022 parallel to the short axis direction. The first suspension 2221 and the first auxiliary magnet 331 are relatively spaced apart along the vibration direction 03.

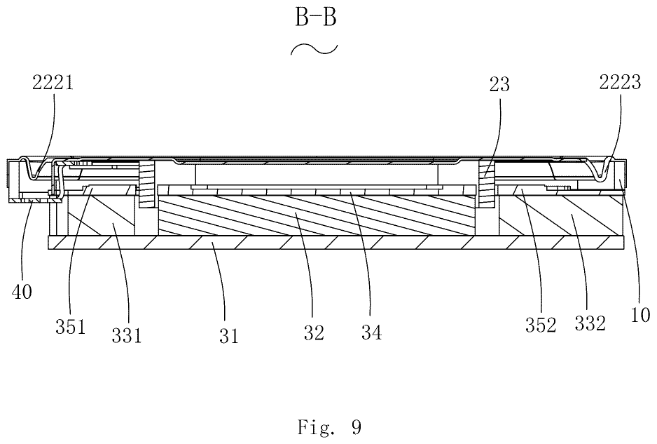

In other embodiments, referring to FIGS. 8 and 9, the balance of the vibration system 20 can also be improved by increasing the thickness of the second suspension 2222 of the diaphragm 22 in the vibration direction 03. The second suspension 2222 includes a thickened portion 2223, and the thickness of the thickened portion 2223 in the vibration direction 03 is greater than the thickness of the first suspension 2221 in the vibration direction 03. According to actual requirements, part of the second suspension 2222 can be set as the thickened portion 2223, or the entire second suspension 2222 can be set as the thickened portion 2223. In this case, the thickness of the second suspension 2222 in the vibration direction 03 is greater than the thickness of the first suspension 2221 in the vibration direction 03.

Compared with the prior art, the speaker 100 of the present application has one FPC board 40 disposed between the first auxiliary magnet 331 and the frame 10, and no FPC board 40 is needed between the second auxiliary magnet 332 and the frame 10. Therefore, the width of the second auxiliary magnet 332 can be increased to increase the volume of the magnetic circuit system 30 and effectively improve the acoustic performance of the speaker. More preferably, the width of the second auxiliary magnet 332 can be increased until it is relatively disposed with the frame 10 along the vibration direction 03, further improving the acoustic performance of the speaker.

The foregoing is merely illustrative of embodiments of the present invention, and it should be noted that modifications may be made to those skilled in the art without departing from the spirit of the invention but are intended to be within the scope of the inventio.

What is claimed is:

1. A speaker, comprising a frame having an accommodation space, a vibration system accommodated in the frame, and a magnetic circuit system driving the vibration system to vibrate; wherein
the magnetic circuit system comprises a yoke spaced apart from the frame, a main magnet fixed on the yoke, and an auxiliary magnet spaced apart from the main magnet;
the vibration system comprises a diaphragm fixed to the frame and a voice coil driving the diaphragm to vibrate and produce sound; the diaphragm comprises a dome positioned in the middle and a suspension spaced and surrounding the dome; the auxiliary magnet comprises a first auxiliary magnet and a second auxiliary magnet respectively disposed on both sides of the main magnet along a first direction perpendicular to a vibration direction;
the first auxiliary magnet and the frame are spaced apart along the first direction, a width of the second auxiliary magnet along the first direction is greater than a width of the first auxiliary magnet along the first direction; and
the speaker further comprises a flexible printed circuit (FPC) board electrically connected to the voice coil, a number of the FPC board is one and the FPC board is disposed between the frame and the first auxiliary magnet.

2. The speaker as described in claim 1, wherein along the first direction, a geometric center of the voice coil is located on a side of a geometric center of the diaphragm away from the FPC board.

3. The speaker as described in claim 1, wherein the diaphragm is rectangular, the suspension comprises a first suspension and a second suspension symmetrically disposed along a center line parallel to a short axis direction, and the first suspension and the first auxiliary magnet are relatively spaced apart along the vibration direction.

4. The speaker as described in claim 3, wherein the second suspension comprises a thickened portion, and a thickness of the thickened portion is greater than a thickness of the first suspension.

5. The speaker as described in claim 3, wherein a thickness of the second suspension is greater than a thickness of the first suspension.

6. The speaker as described in claim 1, wherein the second auxiliary magnet and the frame are relatively disposed along the vibration direction.

7. The speaker as described in claim 1, wherein the frame is rectangular, and the first direction is parallel to a long axis direction of the frame.

8. The speaker as described in claim 1, wherein the magnetic circuit system further comprises a main pole piece located above the main magnet and an auxiliary pole piece located above the auxiliary magnet, the auxiliary pole piece comprises a first auxiliary pole piece and a second auxiliary pole piece respectively disposed on both sides of the main pole piece along the first direction, and a width of the second auxiliary pole piece in the first direction is greater than a width of the first auxiliary pole piece in the first direction.

9. The speaker as described in claim 1, wherein the dome comprises a planar portion perpendicular to the vibration direction and a side surface portion extending from a short axis edge of the planar portion toward the magnetic circuit system; the FPC board comprises a bending portion close to the voice coil and adhered to the planar portion, a first fixing portion fixed to the frame, a second fixing portion fixed to the side surface portion, a perpendicular portion connecting the bending portion and the second fixing portion, and a resilient arm connecting the first fixing portion and the second fixing portion.
